(19) United States
(12) Patent Application Publication
(10) Pub. No.: US 2008/0073928 A1
(43) Pub. Date: Mar. 27, 2008

(54) Tray for a vehicle

(76) Inventor: Jung Hoon Woo, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/645,274

(22) Filed: Dec. 22, 2006

(30) Foreign Application Priority Data
Sep. 21, 2006 (KR) 10-2006-0091789

(51) Int. Cl. B60R 27/00

(52) U.S. Cl. 296/37.12; 296/24.34

(57) ABSTRACT

The present invention relates to a tray for a vehicle installed to a center console of a vehicle. A tray for a vehicle includes a bumper disposed between a tray cover and a body defining a receiving space so as to alleviate impact when the cover is closed thereby preventing noise. A plurality of protrusions for converting a surface contact between the cover and the bumper to a point contact are formed.

### CROSS-REFERENCE TO RELATED APPLICATION

This application claims priority to Korean Patent Application No. 10-2006-0091783 filed in the Korean Intellectual Property Office on Sep. 21, 2006, the disclosure of which is incorporated herein by reference.

### BACKGROUND OF THE INVENTION

(a) Field of the Invention

The present invention relates to a tray for a vehicle which is installed to a center console of a vehicle.

(b) Description of the Related Art

Generally, a tray is provided in a passenger compartment of a vehicle for convenience. For example, the tray may also include an ash tray and a cup holder. Additionally, a compact disc holder may also be adjacent to or be part of the tray in the passenger compartment.

The tray is typically provided at a center console of an instrument panel, and a tray cover for opening and closing of the inner space of the tray is rotatably connected.

In other words, the tray cover closes the inner space of the tray while the tray is not being used. The tray cover opens such that articles contained in the inner space of the tray can be easily taken out.

However, the conventional tray has a problem of poor opening and closing of the tray cover which is caused by the freezing of moisture at a contacting surface of the tray cover and the bumper at low temperatures (i.e. sub-zero).

### SUMMARY OF THE INVENTION

The present invention provides a tray installed in a center console of a vehicle in which a plurality of protrusions for converting a surface contact between a tray cover and a bumper into a point contact is formed. The present invention solves the problem of poor opening and closing of the tray caused by dew condensation at very low temperatures.

In an exemplary embodiment of the present invention, a tray for a vehicle including a bumper disposed between a tray cover and a body defining a receiving space is provided so as to alleviate impact when the cover is closed thereby preventing noise.

In another embodiment, the protrusions may be regularly arranged in horizontally and vertically-spaced lines within a specific area of a contacting surface of the cover.

In yet another embodiment, the protrusions may be regularly arranged in horizontally and vertically-spaced points within a specific area of a contacting surface of the cover.

### BRIEF DESCRIPTION OF THE DRAWINGS

FIG. 1 is a perspective view of a tray for a vehicle according to an exemplary embodiment of the present invention.

FIG. 2 is a cross sectional view of a tray for a vehicle according to an exemplary embodiment of the present invention.

FIG. 3 is a perspective view of a protrusion formed on a cover of a tray for a vehicle according to an exemplary embodiment of the present invention.

### DESCRIPTION OF REFERENCE NUMERALS INDICATING PRIMARY ELEMENTS IN THE DRAWINGS

| | |
|---|---|
| 10: tray | 11: body |
| 12: cover | 13: bumper |
| 13a: head | 20: protrusion |

### DETAILED DESCRIPTION OF THE INVENTION

An exemplary embodiment of the present invention will hereinafter be described in detail with reference to the accompanying drawings.

A tray which is installed to a center console of a vehicle according to an exemplary embodiment of the present invention is configured to solve the problem of poor opening and closing due to dew condensation generated in the contacting surface of a cover 12 and a bumper 13 at very low temperatures.

As shown in FIG. 1, a tray 10 includes a body 11 defining a space for housing articles therein, and is generally provided at a center console (not shown) of an instrument panel.

The cover 12 is for opening or closing the inner space which is rotatably connected to a front portion of the tray 10, and a latch (not shown) for regulating the rotation of the cover 12.

In addition, the bumpers 13 are formed at upper ends of both sides of the body 11 facing the cover 12. When the bumpers 13 collide with the cover 12, the cover 12 is closed so as to alleviate impact thereby preventing noises.

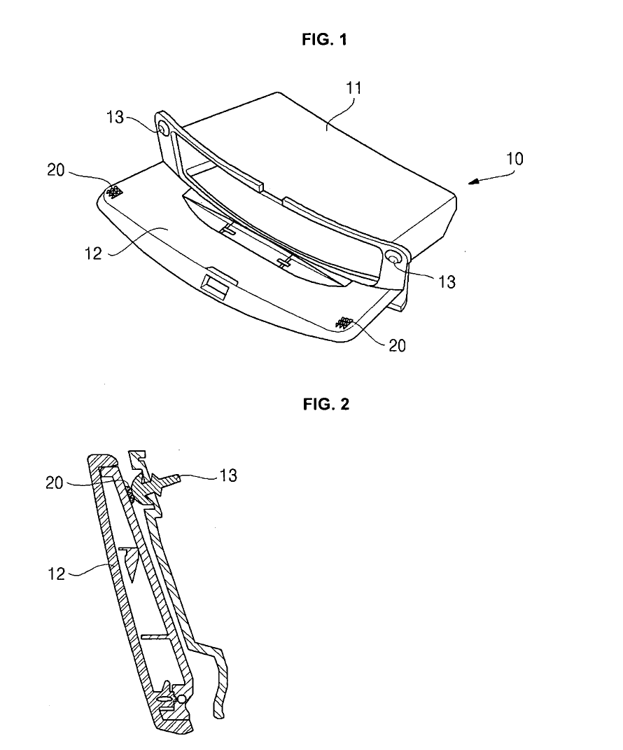

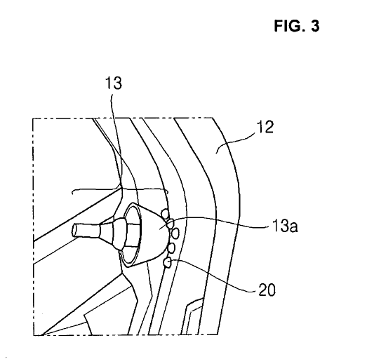

As shown in FIG. 2, the bumper 13 is formed of rubber material which is able to alleviate closing impact of the rotating cover 12. A head 13a is fixed to a front surface of the body 11 and is protruded from a front surface of the body 11 by a predetermined length.

In an exemplary embodiment of the present invention, a plurality of hemisphere shaped protrusions 20, having a smaller size than a contacting surface of the bumper 13, are formed on an inner surface of the cover 12. The protrusions 20 are regularly arranged in horizontally and vertically-spaced lines in a specific area. In addition, the protrusions 20 are regularly arranged in horizontally and vertically-spaced points in a specific area.

Accordingly, referring to the drawing, the bumper 13 does not surface-contact with the cover 12. However, the front ends of the plurality of protrusions 20 point-contact with the bumper 13. Therefore, the protrusions convert a surface contact between the bumper 13 and the cover 12 to a point contact. A surface contact refers to the surfaces of the bumper 13 and the cover 12 in contact with each other. A point contact refers to the bumper 13 and the cover 12 in contact with each other in at least one point. As the area of the contacting surface of the protrusions 20 and the bumper 13 is smaller (i.e., freezing area is smaller) the point-contact effect is further enhanced.

Accordingly, in a tray according to an exemplary embodiment of the present invention, the plurality of protrusions 20 are formed on a contacting surface of the cover 12, thereby solving the problem of opening and closing caused by dew condensation on the contacting surface of the cover 12 and the bumper 13.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A tray for a vehicle comprising a bumper disposed between a tray cover and a body thereby defining a receiving space and wherein a plurality of protrusions converts a surface contact between the cover and the bumper to a point contact are formed.

2. The tray of claim 1, wherein the protrusions are regularly arranged in horizontally and vertically-spaced lines within a specific area of a contacting surface of the cover.

3. The tray of claim 1, wherein the protrusions are regularly arranged in horizontally and vertically-spaced points within a specific area of a contacting surface of the cover.
